(19) United States
(12) Patent Application Publication
(10) Pub. No.: US 2023/0402946 A1
(43) Pub. Date: Dec. 14, 2023

(54) MOTOR DRIVING APPARATUS, REFRIGERATION CYCLE EQUIPMENT, AND AIR CONDITIONER

(71) Applicant: Mitsubishi Electric Corporation, Tokyo (JP)

(72) Inventors: Shinya TOYODOME, Tokyo (JP); Kazunori HATAKEYAMA, Tokyo (JP); Shoei TSUTSUMI, Tokyo (JP)

(21) Appl. No.: 18/249,079

(22) PCT Filed: Dec. 17, 2020
(86) PCT No.: PCT/JP2020/047186

§ 371 Date: Apr. 14, 2023

(51) Int. Cl. H02P 21/22; F25B 49/02; F24F 11/86; H02P 27/08

(52) U.S. Cl. CPC H02P 21/22; F25B 49/022; F24F 11/86; H02P 27/085

(57) ABSTRACT

In a control device performing PWM control over an inverter for driving a motor, voltage command values are generated using voltage values obtained by performing proportional and integral calculation on current deviations and non-interference control during normal operation, and the voltage command values are generated without using the result of the integral calculation and performing only the non-interference control, at the time of over-modulation. Moreover, the voltage command values are corrected based on a modulation factor. A correction coefficient is so determined that the AC voltages applied to the motor become close to values proportional to the modulation factor. The motor can be operated over a wide range within an over-modulation range.

### CROSS-REFERENCE TO RELATED APPLICATION

This application is a U.S. National Stage Application of International Application No. PCT/JP2020/047186 filed on Dec. 17, 2020, the contents of which are incorporated herein by reference.

### TECHNICAL FIELD

The present disclosure relates to a motor driving apparatus, refrigeration cycle equipment, and an air conditioner.

### BACKGROUND

Permanent magnet synchronous motors have a high efficiency compared with induction motors, and are used not only for domestic appliances but also for industrial equipment, electric vehicles, and the like. Also, the use of an inverter for variable speed control over a permanent magnet synchronous motor, with PWM control for varying the output frequency and the output voltage value of the inverter is widely practiced.

For the purpose of saving energy in the above-described applications, improvement of the efficiency in the low rotational speed range (light load), and expansion of the drive range in the high rotational speed range (high load) are desired.

It is known to increase the magnet quantity and the windings of the motor to improve the efficiency in the low rotational speed range of the motor. However, when the magnet quantity and the wirings are increased, the induced voltage in the high rotational speed range increases, so that the rotational speed is limited. The induced voltage can be suppressed by the use of magnetic flux weakening control. Also, a method is known by which the limit of operation of the motor is extended by properly performing the magnetic flux weakening control while performing the PWM control over the inverter in an over-modulation range (range in which the modulation factor is larger than 1).

It is known that, generally, a wind-up phenomenon occurs when PI (proportional and integral) control is performed over the current, while performing the PWM control in the over-modulation range. The wind-up phenomenon is a phenomenon in which the error is gradually increased by the PI control, and the current control system becomes unstable. Patent reference 1 shows a method in which the determination of the voltage command value based on the current deviation is performed by P calculation, rather than PI calculation, so as to restrain the wind-up phenomenon, and stabilize the control system.

### PATENT REFERENCES

Patent Reference 1: Japanese Patent Publication No. 2002-223599 (Paragraphs 0106 to 0108)

However, in the method described in Patent Reference 1, in the range in which the modulation factor is large, for example, the range in which the modulation factor is 1.5 or more, within the over-modulation range, the motor cannot be controlled stably.

### SUMMARY

An object of the present disclosure is to enable stable operation of the motor over a wide range within the over-modulation range.

A motor driving apparatus according to the present disclosure has
an inverter to generate AC voltages with a variable frequency and a variable voltage value and to apply the AC voltages to a motor, and
a control device to control said inverter, wherein
said control device
generates a q-axis current command value based on a frequency deviation which is a difference of a frequency of said AC voltages with respect to a frequency command value,
generates a first d-axis voltage value by performing proportional calculation on a d-axis current deviation which is a difference of a d-axis current of said motor with respect to a d-axis current command value,
generates a second d-axis voltage value by performing integral calculation on said d-axis current deviation,
calculates a d-axis compensation value for compensating a d-axis voltage induced by said q-axis current command value,
generates a first q-axis voltage value by performing proportional calculation on a q-axis current deviation which is a difference of a q-axis current of said motor with respect to said q-axis current command value,
generates a second q-axis voltage value by performing integral calculation on said q-axis current deviation, and
calculates a q-axis compensation value for compensating a q-axis voltage induced by said d-axis current command value, wherein
in a first mode, said control device
generates a third d-axis voltage value using said first d-axis voltage value, said second d-axis voltage value, and said d-axis compensation value, and
generates a third q-axis voltage value using said first q-axis voltage value, said second q-axis voltage value, and said q-axis compensation value, and
in a second mode, said control device
generates said third d-axis voltage value using at least said d-axis compensation value and without using said second d-axis voltage value, among said first d-axis voltage value, said second d-axis voltage value, and said d-axis compensation value, and
generates said third q-axis voltage value using at least said q-axis compensation value, and without using said second q-axis voltage value, among said first q-axis voltage value, said second q-axis voltage value, and said q-axis compensation value, and
said control device
calculates a modulation factor based on said third d-axis voltage value and said third q-axis voltage value,
calculates a correction coefficient based on said modulation factor,
generates a d-axis voltage command value and a q-axis voltage command value by multiplying said third d-axis voltage value and said third q-axis voltage value by said correction coefficient,
generates signals for PWM control over said inverter based on said d-axis voltage command value and said q-axis voltage command value,
wherein
said correction coefficient is maintained at 1 in said first mode, and
in said second mode, said correction coefficient is so determined that said AC voltages will be of a magnitude corresponding to said third d-axis voltage value and said third q-axis voltage value.

According to the present disclosure, the motor can be made to operate stably over a wide range within the over-modulation range.

### BRIEF DESCRIPTION OF THE DRAWINGS

FIG. 1 is a schematic diagram showing an example of a refrigeration cycle of an air conditioner.

FIG. 2 is a diagram showing a motor driving apparatus of a first embodiment.

FIG. 3 is a diagram showing an example of a configuration of an inverter in FIG. 2.

FIG. 4 is a functional block diagram showing an example of a control device used in the first embodiment.

FIG. 5 is a functional block diagram showing an example of a configuration of a d-axis current command value generator in FIG. 4.

FIG. 6 is a functional block diagram showing an example of a configuration of a voltage command value generator in FIG. 4.

FIG. 7 is a functional block diagram showing an example of a configuration of a speed controller in FIG. 6.

FIG. 8 is a functional block diagram showing an example of a configuration of a voltage value calculator in FIG. 6.

FIG. 9 is a diagram showing a relation between a modulation factor and a correction coefficient.

FIG. 10 is a functional block diagram showing an example of a configuration of a modulation factor calculator in FIG. 6.

FIGS. 11(a) to 11(d) are diagrams showing an example of variations in speed values of the motor, torque of the motor, torque of the load, d-axis current values, q-axis current values, and an input voltage of the inverter when a wind-up phenomenon is taking place.

FIG. 12 is a diagram showing an example of a relation between the modulation factor and an output voltage of the inverter.

FIG. 13 is a diagram showing a voltage command vector when correction of the modulation factor is not performed, and the voltage command vector when the correction of the modulation factor is performed.

FIGS. 14(a) to 14(d) are diagrams showing an example of variations in the speed values of the motor, the torque of the motor, the torque of the load, the d-axis current values, the q-axis current values, and the input voltage of the inverter when the wind-up phenomenon is not taking place.

FIGS. 15(a) to 15(d) are diagrams showing examples of deviations of the actual currents from the current command values, when the d-axis inductance used for the control and the actual d-axis inductance do not agree.

### DETAILED DESCRIPTION

Description will now be made on a motor driving apparatus according to an embodiment, with reference to the attached drawings.

The motor driving apparatus is, for example, for driving a compressor in refrigeration cycle equipment of an air conditioner.

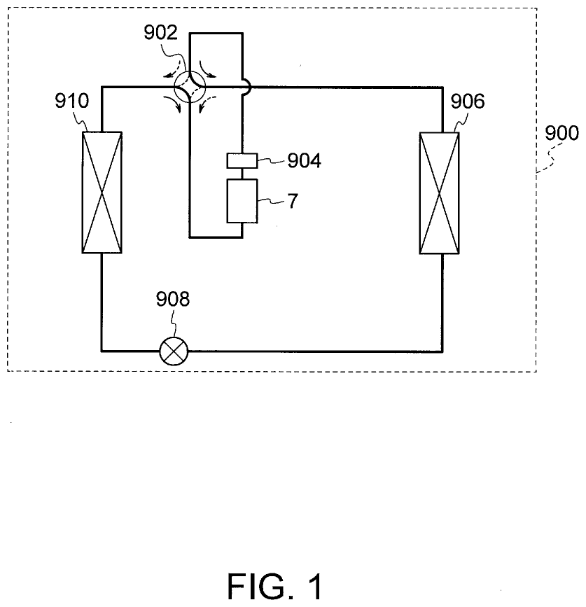

First, a refrigeration cycle in an example of an air conditioner will be described with reference to FIG. 1.

The refrigeration cycle 900 in FIG. 1 can perform either heating operation or cooling operation by the switching action of a four-way valve 902.

At the time of heating operation, as shown by solid line arrows, refrigerant is pressurized by and sent out from a compressor 904, is passed through the four-way valve 902, an indoor heat exchanger 906, an expansion valve 908, an outdoor heat exchanger 910, and the four-way valve 902, and is returned to the compressor 904.

At the time of cooling operation, as shown by dashed line arrows, the refrigerant is pressurized by and sent out from the compressor 904, is passed through the four-way valve 902, the outdoor heat exchanger 910, the expansion valve 908, the indoor heat exchanger 906, and the four-way valve 902, and is returned to the compressor 904.

At the time of the heating operation, the indoor heat exchanger 906 functions as a condenser to dissipate heat, and the outdoor heat exchanger 910 functions as an evaporator to absorb heat. At the time of the cooling operation, the outdoor heat exchanger 910 functions as a condenser to dissipate heat, and the indoor heat exchanger 906 functions as an evaporator to absorb heat. The expansion valve 908 expands the refrigerant by reducing the pressure.

The compressor 904 is driven by a variable speed controlled motor 7.

The refrigeration cycle 900 described above, the motor 7 for driving the compressor 904, and a motor driving apparatus for driving the motor 7 in combination form refrigeration cycle equipment.

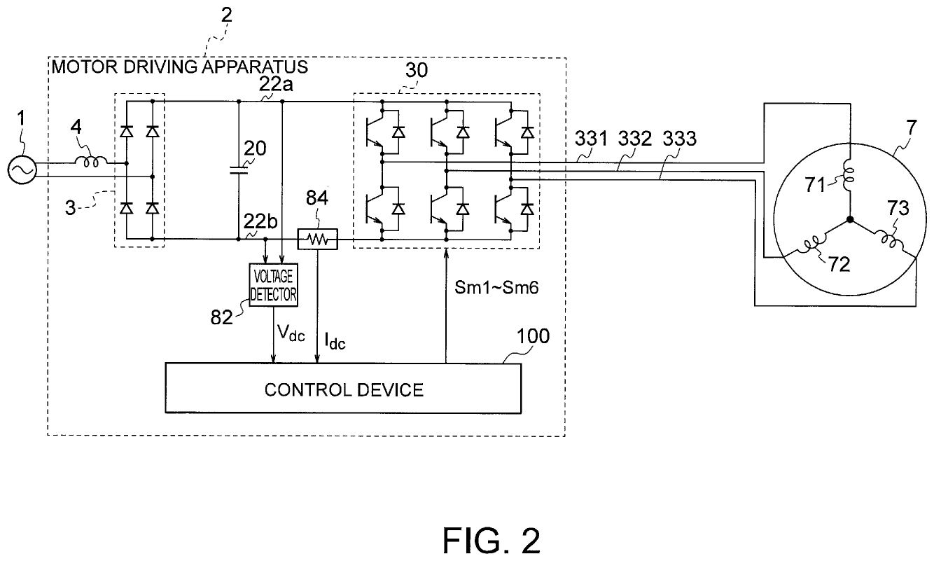

FIG. 2 is a schematic wiring diagram showing a motor driving apparatus 2 of a first embodiment, together with the motor 7. The motor driving apparatus 2 shown in FIG. 2, the motor 7, and the refrigeration cycle 900 shown in FIG. 1 in combination form refrigeration cycle equipment.

The motor driving apparatus 2 shown in FIG. 2 is for driving the motor 7, and has a reactor 4, a rectifying circuit 3, a smoothing capacitor 20, an inverter 30, a voltage detector 82, an input current detector 84, and a control device 100.

The rectifying circuit 3 converts AC power from an AC power supply 1 into DC power. In the illustrated example, the rectifying circuit 3 is formed of a diode bridge. Input terminals of the diode bridge are connected to the AC power supply 1, and output terminals of the diode bridge are connected to the smoothing capacitor 20.

The smoothing capacitor 20 smoothes an output voltage of the rectifying circuit 3.

One of the electrodes (positive electrode) of the smoothing capacitor 20 is connected to a first output terminal of the rectifying circuit 3, and a DC bus bar 22a of a high potential side (positive side).

The other electrode (negative electrode) of the smoothing capacitor 20 is connected to a second output terminal of the rectifying circuit 3, and a DC bus bar 22b of a low potential side (negative side).

The inverter 30 receives the DC voltage across the two electrodes of the smoothing capacitor 20, and generates three-phase AC voltages of a variable frequency and a variable voltage value, and supplies the AC voltages to the motor 7 via output lines 331 to 333. The DC voltage inputted to the inverter 30 is referred to as an input voltage of the inverter, or simply as an input voltage.

For example, the motor 7 is a three-phase permanent magnet synchronous motor.

The voltage detector 82 detects the DC voltage Vdc across the DC bus bars 22a and 22b, as the input voltage of the inverter. For example, the voltage detector 82 includes a circuit for dividing the input voltage Vdc using series connected resistors, for conversion into a voltage, e.g., of not higher than 5V, suitable for processing in a microcomputer within the control device 100. This signal (voltage detection signal) is converted into a digital signal by an A/D converter, not shown, in the control device 100, and used for processing within the control device 100.

The input current detector 84 detects an input current Idc of the inverter 30. The input current detector 84 includes a shunt resistor inserted in the DC bus bar 22b between the negative electrode of the smoothing capacitor 20 and the inverter 30, and supplies an analog signal indicating the result of the detection, to the control device 100. This signal (current detection signal) is converted by an A/D converter, not shown, in the control device 100, into a digital signal, and is used for the processing within the control device 100.

For control over the inverter 30, the control device 100 generates PWM signals Sm1 to Sm6, and supplies them to the inverter 30.

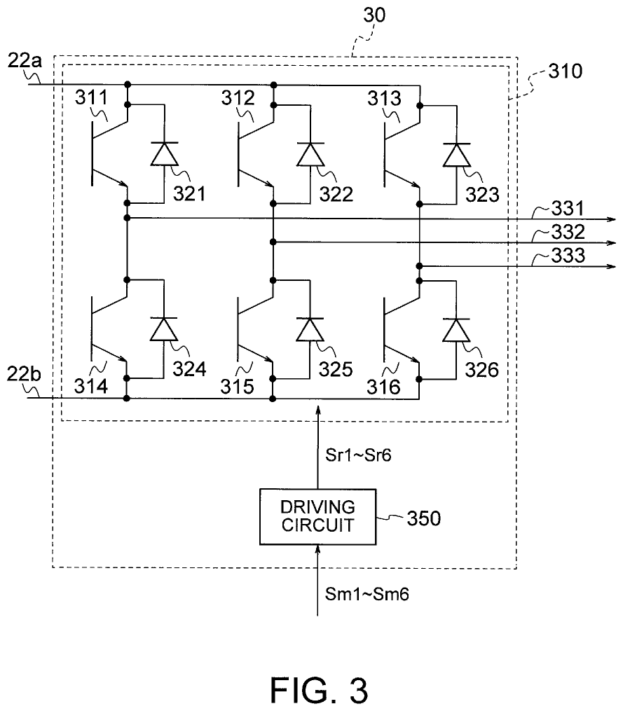

As shown in FIG. 3, the inverter 30 has an inverter main circuit 310 and a driving circuit 350, and input terminals of the inverter main circuit 310 are connected to the DC bus bars 22a and 22b.

The inverter main circuit 310 has six arms respectively including switching elements 311 to 316. Connected in reverse parallel with the switching elements are free-wheeling rectifying elements 321 to 326.

Based on the PWM signals Sm1 to Sm6, the driving circuit 350 generates drive signals Sr1 to Sr6, and controls the on-off of the switching elements 311 to 316 using the drive signals Sr1 to Sr6, thereby to cause three-phase AC voltages of a variable frequency and a variable voltage value, to be applied via the output lines 331 to 333 to the motor 7.

The PWM signals Sm1 to Sm6 are of a magnitude (0 to 5V) of a signal level for a logic circuit, whereas the drive signals Sr1 to Sr6 are signals having a magnitude of a voltage level, e.g., +15V to −15V, required to control the switching elements 311 to 316. Also, for the PWM signals Sm1 to Sm6, the ground potential of the control device 100 is taken as a reference, whereas, for each of the drive signals Sr1 to Sr6, the potential at the negative-side terminal (emitter terminal) of the corresponding switching element is taken as a reference.

As mentioned above, the control device 100 controls the operation of the inverter 30.

Specifically, the control device 100 controls the inverter 30 to vary the frequency and the voltage value of output voltages of the inverter 30.

The angular frequency ω of the output voltages of the inverter 30 determines a rotational angular speed (denoted by the same sign a as the angular frequency of the output voltages) of the motor 7 in terms of the electrical angle, and a rotational angular speed om of the motor 7 in terms of the mechanical angle is equal to the rotational angular speed a of the motor 7 in terms of the electrical angle, divided by the pole-pair number Pₘ. Accordingly, there is a relation represented by the following equation (1) between the rotational angular speed om of the motor 7 in terms of the mechanical angle and the angular frequency ω of the output voltages of the inverter 30.

$$\begin{matrix}[ Mathematical Expression 1 ] & \\ {ω}_{m} = \frac{ω}{{P}_{m}} & ( 1 )\end{matrix}$$

In the present application, the rotational angular speed may simply be referred to as a rotational speed, and the angular frequency may simply be referred to as a frequency.

The control device 100 controls the inverter 30 by calculating a d-axis current Id and a q-axis current Iq in a rotational coordinate system, based on phase currents Iu, Iv and Iw of the motor 7, generating a d-axis current command value Id* based on the input voltage Vdc and the q-axis current Iq, generating a d-axis voltage command value Vd* and a q-axis voltage command value Vq* based on a frequency command value ω*, the d-axis current command value Id*, and the d-axis current Id and the q-axis current Iq, and generating the PWM signals Sm1 to Sm6 for inverter control based on the d-axis voltage command value Vd* and the q-axis voltage command value Vq*.

The control device 100 is formed of a microprocessor. The microprocessor may be a processor or a processing device which may be called a CPU (Central Processing Unit), a microcomputer, or a DSP (Digital Signal Processor).

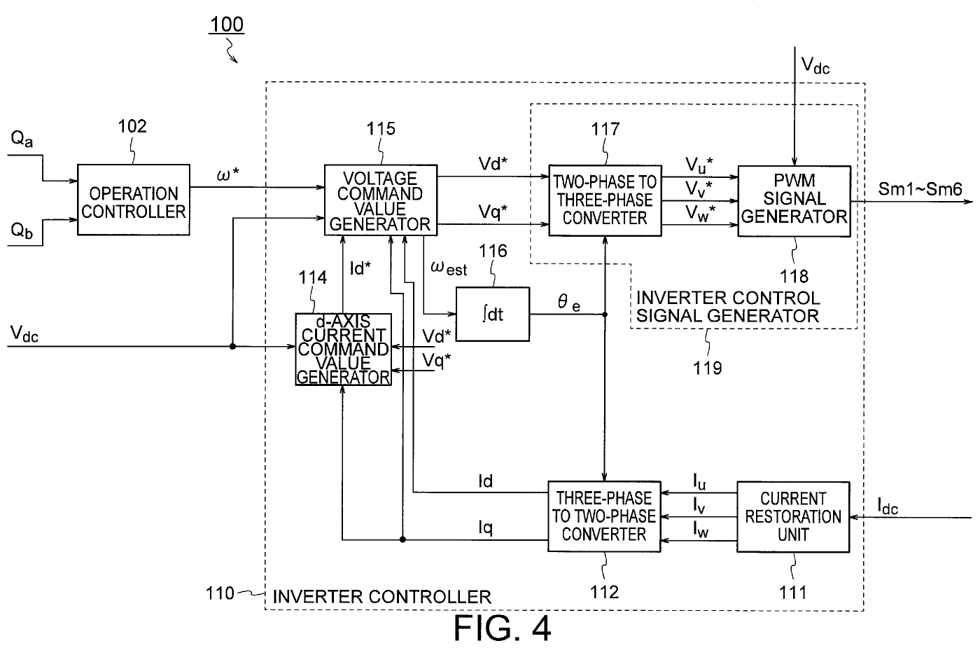

FIG. 4 is a functional block diagram showing an example of the control device 100. As illustrated, the control device 100 has an operation controller 102 and an inverter controller 110.

The operation controller 102 outputs the frequency command value ω*. The frequency command value ω* is determined by multiplying a command value (rotational angular speed command value) ωₘ* of the rotational speed of the motor 7 by the pole-pair number Pₘ, as shown by the following equation (2).

[Mathematical Expression 2]

ω*=ωₘ*×Pₘ (2)

The operation controller 102 receives information Qa indicating the temperature (temperature of the air-conditioned space) detected by a temperature sensor, not shown, receives instructions Qb from an operation unit such as a remote controller, not shown, and controls the operation of the various parts of the air conditioner. The instructions from the operation unit include information indicating the set temperature, the selection of the operation mode (heating, cooling, dehumidification, or the like), and instructions for starting and stopping the operation.

The inverter controller 110 has a current restoration unit 111, a three-phase to two-phase converter 112, a d-axis current command value generator 114, a voltage command value generator 115, an electrical phase calculator 116, a two-phase to three-phase converter 117, and a PWM signal generator 118.

The current restoration unit 111 restores the phase currents Iu, Iv and Iw flowing into the motor 7, based on the input current Idc detected by the input current detector 84. The current restoration unit 111 restores the phase currents Iu, Iv and Iw by sampling the input current Idc detected by the input current detector 84, at timings determined based on the PWM signals Sm1 to Sm6 from the PWM signal generator 118.

The three-phase to two-phase converter 112 converts the phase currents Iu, Iv and Iw restored by the current restoration unit 111, into the d-axis current Id and the q-axis current Iq using an electrical phase θe generated by the electrical phase calculator 116 to be described later.

The d-axis current command value generator 114 generates the d-axis current command value Id* based on the input voltage Vdc detected by the voltage detector 82, the q-axis current Iq obtained by the conversion at the three-phase to two-phase converter 112, and the d-axis voltage command value Vd* and the q-axis voltage command value Vq* generated by the voltage command value generator 115, and outputs the generated d-axis current command value Id*.

The voltage command value generator 115 receives, as inputs, the d-axis current Id and the q-axis current Iq obtained by the three-phase to two-phase converter 112, the frequency command value ω* outputted from the operation controller 102, the d-axis current command value Id* obtained by the d-axis current command value generator 114, and the input voltage Vdc detected by the voltage detector 82, generates the voltage command values Vd* and Vq* based on these inputs, and outputs the generated voltage command values Vd* and Vq*.

The voltage command value generator 115 also determines an estimated value ωₑₛₜ of the frequency from the voltage command values Vd* and Vq*, as well as the d-axis current Id and the q-axis current Iq, and outputs the estimated value ωₑₛₜ.

The voltage command value generator 115 operates in a first mode or a second mode. The voltage command value generator 115 operates in the first mode at the time of normal operation, and in the second mode at the time of over-modulation. For example, it operates in the first mode until a modulation factor Fm for the PWM control described later reaches a first threshold value Fmta, and transits to the second mode when the modulation factor Fm becomes larger than the first threshold value Fmta. When the modulation factor Fm becomes smaller than a second threshold value Fmtb during the operation in the second mode, it returns to the first mode. The second threshold value Fmtb may be equal to the first threshold value Fmta, or may be smaller than the first threshold value Fmta. The method in which the voltage command values Vd* and Vq* are generated is different between the first mode and the second mode.

The electrical phase calculator 116 calculates the electrical phase θe by integrating the estimated value ωₑₛₜ of the frequency outputted from the voltage command value generator 115.

The two-phase to three-phase converter 117 converts the d-axis voltage command value Vd* and the q-axis voltage command value Vq* (voltage command values in a two-phase coordinate system) obtained by the voltage command value generator 115, into output voltage command values (three-phase voltage command values) Vu*, Vv* and Vw* in a three-phase coordinate system, using the electrical phase θe obtained by the electrical phase calculator 116, and outputs the resultant output voltage command values Vu*, Vv* and Vw*.

The PWM signal generator 118 generates the PWM signals Sm1 to Sm6 on the basis of the input voltage Vdc detected by the voltage detector 82, and the three-phase voltage command values Vu*, Vv* and Vw* obtained by the two-phase to three-phase converter 117, and outputs the generated PWM signals Sm1 to Sm6.

The two-phase to three-phase converter 117 and the PWM signal generator 118 in combination form an inverter control signal generator 119.

The inverter control signal generator 119 generates the PWM signals Sm1 to Sm6 based on the d-axis voltage command value Vd* and the q-axis voltage command value Vq*.

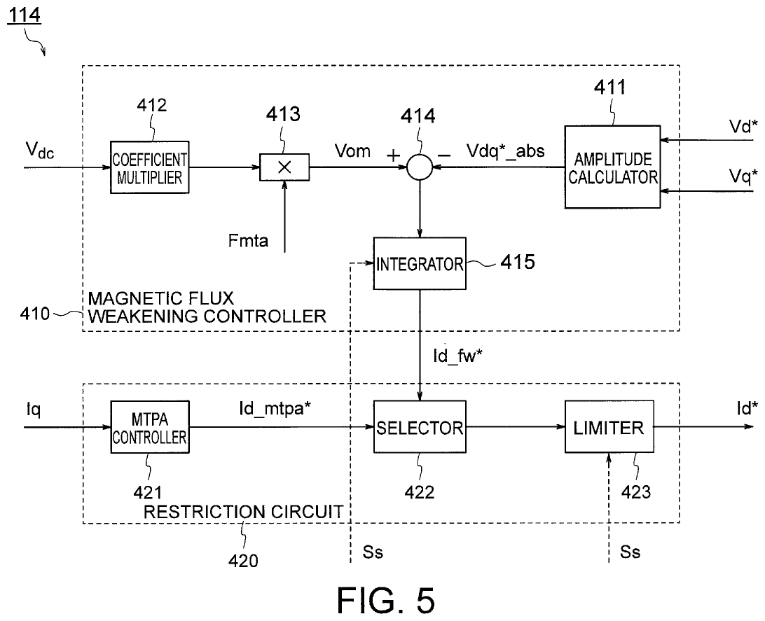

For example, the d-axis current command value generator 114 has a magnetic flux weakening controller 410, and a restriction circuit 420, as shown in FIG. 5.

The magnetic flux weakening controller 410 generates a d-axis current value Id_fw* based on the input voltage Vdc and the voltage command values Vd* and Vq*. The d-axis current value Id_fw* is a d-axis current command value for the purpose of magnetic flux weakening control.

The magnetic flux weakening controller 410 determines the d-axis current value Id_fw* (d-axis current command value for the magnetic flux weakening control) by means of integral-type magnetic flux weakening control.

The magnetic flux weakening controller 410 has an amplitude calculator 411, a coefficient multiplier 412, a multiplier 413, and an integrator 415.

The amplitude calculator 411 calculates an amplitude Vdq*_abs of a voltage command vector based on the voltage command values Vd* and Vq* which are obtained by the voltage command value generator 115 in a manner described later. Vdq* abs is calculated according to the following equation (3).

[Mathematical Expression 3]

Vdq*_abs=\sqrt{Vd*²+Vq*²} (3)

The coefficient multiplier 412 multiplies the input voltage Vdc by 1/√2.

The multiplier 413 multiplies the output of the coefficient multiplier 412 by the above-mentioned first threshold value Fmta, to output a restriction value Vom. The first threshold value Fmta is a modulation factor at which the magnetic flux weakening control is commenced.

The subtractor 414 subtracts the amplitude Vdq* abs from the restriction value Vom to determine a difference.

The integrator 415 multiplies the difference determined by the subtractor 414 by a coefficient Kifw, and integrates the product to generate the d-axis current value Id_fw*.

The d-axis current value Id_fw* outputted from the integrator 415 becomes the output of the magnetic flux weakening controller 410.

The d-axis current value Id_fw* gradually becomes larger in the negative direction when the amplitude Vdq*_abs of the voltage command vector is larger than the restriction value Vom, and gradually becomes smaller in the negative direction (its absolute value gradually becomes smaller) when the amplitude Vdq*_abs of the voltage command vector is smaller than the restriction value Vom.

The restriction circuit 420 applies restriction using limit values defining an upper limit and a lower limit on the d-axis current value Id_fw*, to generate the d-axis current command value Id*.

The restriction circuit 420 has an MTPA controller 421, a selector 422, and a limiter 423.

On the basis of the q-axis current Iq, the MTPA controller 421 determines a d-axis current command value Id_mtpa* at which the efficiency is the highest for driving the motor 7.

The d-axis current command value Id_mtpa* is what is called a “current command value for the maximum torque/current control (maximum torque per ampere control)”.

The selector 422 selects either one of the d-axis current command value Id_mtpa* and the d-axis current value Id_fw* which is larger in the negative direction (which has a negative value and has a larger absolute value), and outputs the selected value.

The limiter 423 performs a limiting process on the output of the selector 422, and outputs the result of the limiting process, as the d-axis current command value Id*. The limiting process at the limiter 423 is for applying restriction on the absolute value of the output of the selector 422, using an upper limit.

The restriction using an upper limit is performed for preventing the d-axis current command value Id* from becoming too large, and the motor 7 from being demagnetized (from being irreversibly demagnetized).

Because the selector 422 selects and outputs one of the output of the MTPA controller 421 and the output of the magnetic flux weakening controller 410, which is the smaller (larger in the negative direction), the d-axis current command value Id* will not come to have a larger value in the positive direction, compared with the d-axis current command value Id_mtpa*. In other words, it can be said that restriction in the positive direction is applied to the d-axis current command value Id* by the combination of the MTPA controller 421 and the selector 422.

Incidentally, in place of the d-axis current command value Id_mtpa* from the MTPA controller 421, the value “zero” may be used as the limit value in the positive direction. In such a case, the MTPA controller 421 is not necessary, and in place of the d-axis current command value Id_mtpa*, the value zero may be inputted to the selector 422.

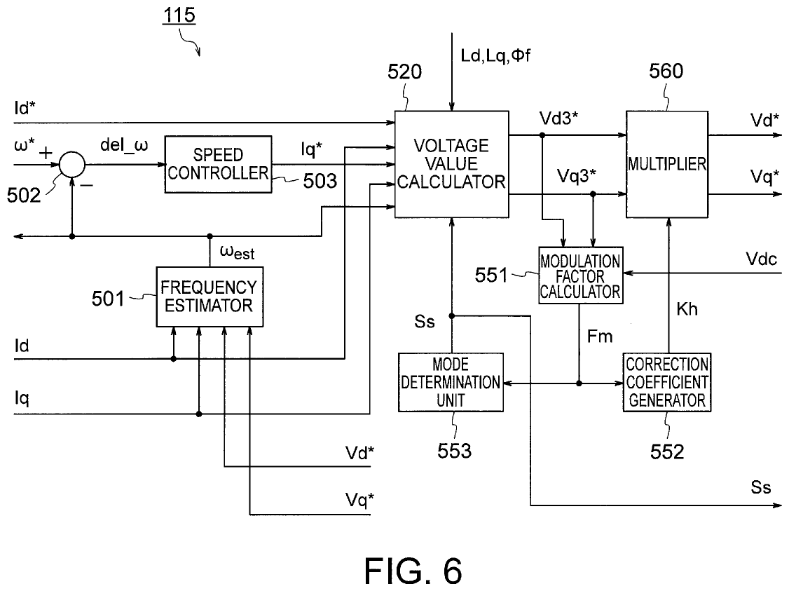

The voltage command value generator 115 is formed, for example, as shown in FIG. 6. The illustrated voltage command value generator 115 has a frequency estimator 501, a subtractor 502, a speed controller 503, a voltage value calculator 520, a modulation factor calculator 551, a correction coefficient generator 552, a mode determination unit 553, and a multiplier 560.

The frequency estimator 501 receives, as inputs, the d-axis current Id and the q-axis current Iq outputted from the three-phase to two-phase converter 112, and the voltage command values Vd* and Vq* outputted from the multiplier 560, and estimates, based on these inputs, the frequency of the voltage applied to the motor 7, and outputs the estimated value ωₑₛₜ.

The subtractor 502 calculates a frequency deviation del_ω (=ω*−ωₑₛₜ) which is a difference of the frequency estimated value ωₑₛₜ generated by the frequency estimator 501, with respect to the frequency command value ω*.

The speed controller 503 performs proportional and integral (PI) calculation on the calculated frequency deviation del_ω, to determine a q-axis current command value Iq* for making the deviation closer to zero. By generating the q-axis current command value Iq* in this manner, control for causing the frequency estimated value ωₑₛₜ to become identical with the frequency command value ω* is performed.

Incidentally, since the rotational speed of the motor 7 is proportional to the frequency of the AC voltages applied to the motor 7, as mentioned above, the control by means of the speed controller 503 can be said to be control for making the deviation of a speed estimated value with respect to the speed command value closer to zero.

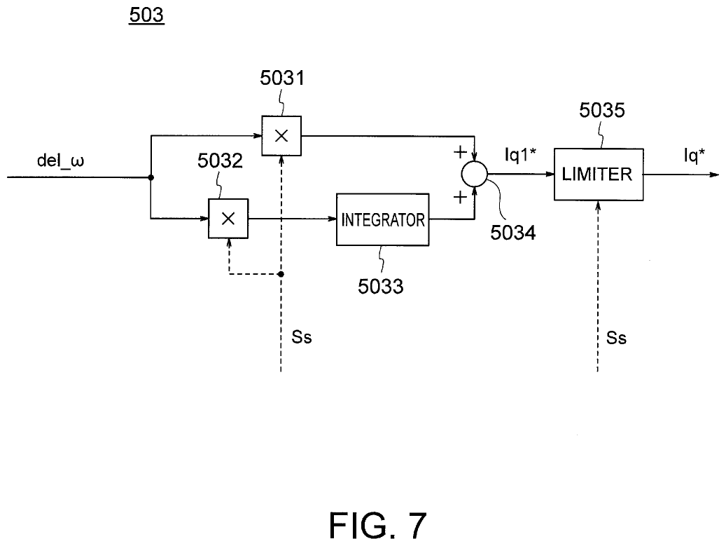

For example, the speed controller 503 has coefficient multipliers 5031 and 5032, an integrator 5033, an adder 5034, and a limiter 5035, as shown in FIG. 7.

The coefficient multiplier 5031 multiplies the frequency deviation del_ω by a predetermined coefficient. The coefficient multiplier 5032 multiplies the frequency deviation del_ω by a predetermined coefficient. The coefficient used by the coefficient multiplier 5031 and the coefficient used by the coefficient multiplier 5032 may be of the same value, or of different values.

The integrator 5033 integrates the output of the coefficient multiplier 5032.

The output of the coefficient multiplier 5031 is a result of proportional calculation on the frequency deviation del_ω, while the output of the integrator 5033 is a result of integral calculation on the frequency deviation del_ω.

The adder 5034 adds the output of the coefficient multiplier 5031 and the output of the integrator 5033, and outputs a q-axis current value Iq1*. The q-axis current value Iq1* is a result of proportional and integral (PI) calculation on the frequency deviation del_ω.

The limiter 5035 applies restriction in the positive direction and the negative direction on the q-axis current value Iq1*. The output Iq* of the limiter 5035 is outputted from the speed controller 503, as the q-axis current command value.

The voltage value calculator 520 receives, as inputs, the d-axis current command value Id* outputted from the d-axis current command value generator 114, the q-axis current command value Iq* outputted from the speed controller 503, the d-axis current Id and the q-axis current Iq outputted from the three-phase to two-phase converter 112, the frequency estimated value ωₑₛₜ outputted from the frequency estimator 501, and a mode signal Ss outputted from the mode determination unit 553, and outputs a d-axis voltage value Vd3* and a q-axis voltage value Vq3*.

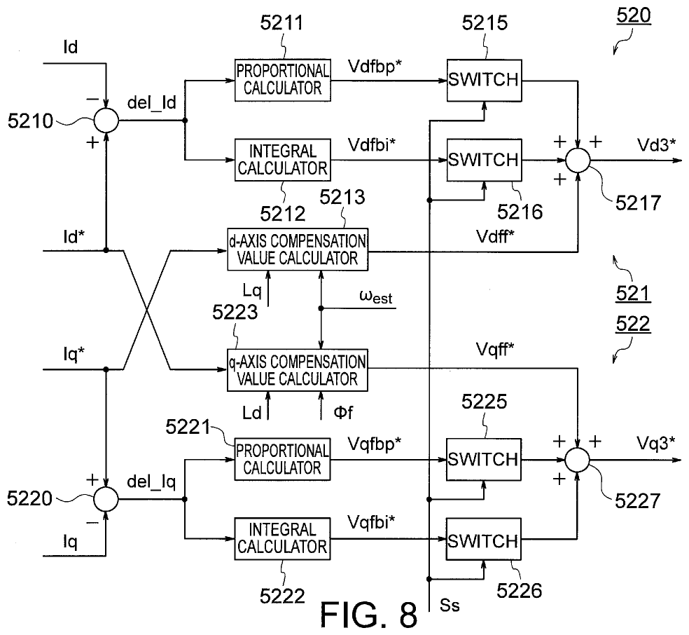

For example, the voltage value calculator 520 has a d-axis voltage value calculator 521 and a q-axis voltage value calculator 522, as shown in FIG. 8.

The d-axis voltage value calculator 521 has a subtractor 5210, a proportional calculator 5211, an integral calculator 5212, a d-axis compensation value calculator 5213, switches 5215 and 5216, and an adder 5217.

The subtractor 5210 subtracts the d-axis current Id from the d-axis current command value Id*, and outputs a d-axis current deviation del_Id (=Id*−Id) representing the difference between them.

The proportional calculator 5211 performs proportional calculation on the d-axis current deviation del_Id, and generates a first d-axis voltage value Vdfbp* representing the result of the proportional calculation. The first d-axis voltage value Vdfbp* is supplied via the switch 5215 to the adder 5217.

The integral calculator 5212 performs integral calculation on the d-axis current deviation del_Id, and generates a second d-axis voltage value Vdfbi* representing the result of the integral calculation. The second d-axis voltage value Vdfbi* is supplied via the switch 5216 to the adder 5217.

The d-axis compensation value calculator 5213 calculates a d-axis compensation value Vdff* based on the q-axis current command value Iq* and the frequency estimated value ωₑₛₜ. The d-axis compensation value Vdff* is a compensation value for cancelling an interference voltage that is generated on the d-axis due to the q-axis current command value Iq*. The interference voltage generated on the d-axis due to the q-axis current command value Iq* means a d-axis voltage induced by the q-axis current command value Iq*. The compensation value Vdff* is determined by calculation represented by a later-mentioned equation (4a). The d-axis compensation value Vdff* is supplied to the adder 5217.

The adder 5217 adds the first d-axis voltage value Vdfbp*, the second d-axis voltage value Vdfbi*, and the d-axis compensation value Vdff*, and outputs the result of the addition as a third d-axis voltage value Vd3*. The third d-axis voltage value Vd3* has a character as a voltage command value.

The q-axis voltage value calculator 522 has a subtractor 5220, a proportional calculator 5221, an integral calculator 5222, a q-axis compensation value calculator 5223, switches 5225 and 5226, and an adder 5227.

The subtractor 5220 subtracts the q-axis current Iq from the q-axis current command value Iq*, and outputs a q-axis current deviation del_Iq (=Iq*−Iq) representing the difference between them.

The proportional calculator 5221 performs proportional calculation on the q-axis current deviation del_Iq, and generates a first q-axis voltage value Vqfbp* representing the result of the proportional calculation. The first q-axis voltage value Vqfbp* is supplied via the switch 5225 to the adder 5227.

The integral calculator 5222 performs integral calculation on the q-axis current deviation del_Iq, and generates a second q-axis voltage value Vqfbi* representing the result of the integral calculation. The second q-axis voltage value Vqfbi* is supplied via the switch 5226 to the adder 5227.

The q-axis compensation value calculator 5223 calculates a q-axis compensation value Vqff* based on the d-axis current command value Id* and the frequency estimated value ωₑₛₜ. The q-axis compensation value Vqff* is a compensation value for cancelling an interference voltage that is generated on the q-axis due to the d-axis current command value Id*. The interference voltage generated on the q-axis due to the d-axis current command value Id* means a q-axis voltage induced by the d-axis current command value Id*. For example, the compensation value Vqff* is determined by calculation represented by a later-mentioned equation (4b). The q-axis compensation value Vqff* is supplied to the adder 5227.

The adder 5227 adds the first q-axis voltage value Vgfbp*, the second q-axis voltage value Vgfbi*, and the q-axis compensation value Vqff*, and outputs the result of the addition as a third q-axis voltage value Vq3*. The third q-axis voltage value Vq3* has a character as a voltage command value.

For the calculation of the compensation values Vdff* and Vqff*, the following equations (4a) and (4b) are used.

[Mathematical Expression 4]

Vdff*=−Iq*×Lq×ωₑₛₜ (4a)

Vqff*=(Id*×Ld+φf)×ωₑₛₜ (4b)

In the above equations (4a) and (4b),

Ld denotes d-axis inductance of the motor 7,

Lq denotes q-axis inductance of the motor 7,

φf denotes interlinking magnetic flux.

The values of the d-axis inductance Ld, the q-axis inductance Lq and the interlinking magnetic flux φf are determined in advance, and stored for example within the voltage value calculator 520.

ωₑₛₜ denotes the frequency estimated value, for which, for example, the value estimated by the frequency estimator 501 is used.

Incidentally, in place of the frequency estimated value ωₑₛₜ, the frequency command value ω* may be used.

The above-mentioned control using the compensation values Vdff* and Vqff* can be regarded as FF (feedforward) control. The control using the compensation values is also called non-interference control.

The switches 5215, 5216, 5225 and 5226 are made to be open or closed according to the mode represented by the mode signal Ss.

The switches 5215, 5216, 5225 and 5226 are closed in the first mode. In this case, the voltage values Vd3* and Vq3* are given by the following equations.

[Mathematical Expression 5]

Vd3*=Vdfbp*+Vdfbi*+Vdff* (5a)

Vq3*=Vqfbp*+Vqfbi*+Vqff* (5b)

The switches 5215, 5216, 5225 and 5226 are open in the second mode. In this case, the voltage values Vd3* and Vq3* are given by the following equations.

[Mathematical Expression 6]

Vd3*=Vdff* (6a)

Vq3*=Vqff* (6b

During high-speed and stable operation, Vdff* and Vqff* are dominant in the equations (5a) and (5b), so that transition from the first mode to the second mode does not cause a large variation in the voltage values Vd3* and Vq3*.

Returning to FIG. 6, the modulation factor calculator 551 calculates the modulation factor Fm based on the third d-axis voltage value Vd3*, the third q-axis voltage value Vq3*, and the input voltage Vdc. The modulation factor Fm is calculated according to the following equation.

$$\begin{matrix}[ Mathematical Expression 7 ] & \\ F m = \frac{\sqrt{Vd {3}^{* 2} + Vq {3}^{* 2}}}{Vdc / \sqrt{2}} & ( 7 )\end{matrix}$$

Based on the modulation factor Fm calculated by the modulation factor calculator 551, the correction coefficient generator 552 generates a correction coefficient Kh.

For example, the correction coefficient generator 552 is formed of a conversion table.

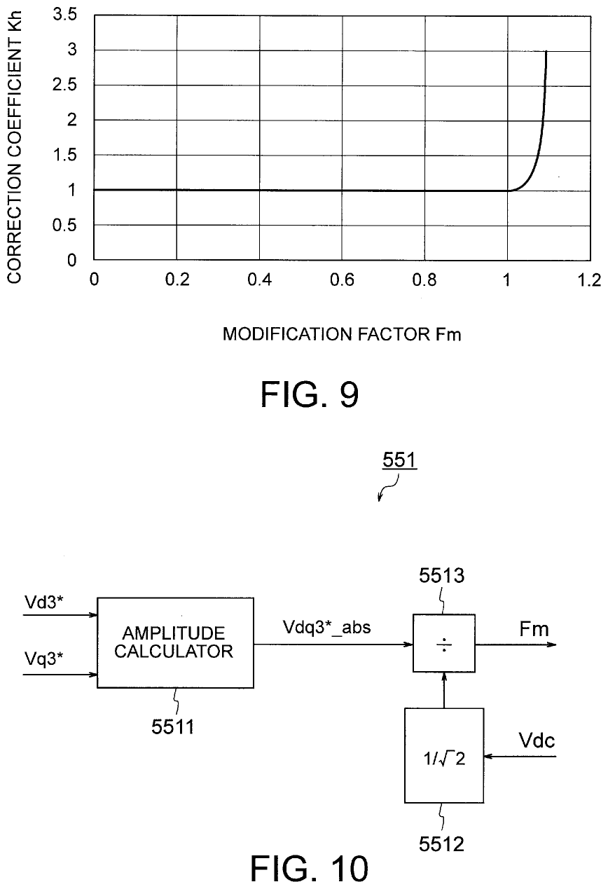

An example of the conversion characteristic of the conversion table is shown in FIG. 9. According to the conversion characteristic shown in FIG. 9, in the range in which the modulation factor Fm is 1 or less, the correction coefficient Kh is 1, whereas in the range in which the modulation factor Fm is more than 1, the correction coefficient Kh gradually increases from 1. The rate of increase in the correction coefficient Kh becomes larger with the increase in the modulation factor Fm.

The mode determination unit 553 determines the operation mode based on the modulation factor Fm. For example, when the modulation factor Fm becomes larger than the first threshold value Fmta, transition from the first mode to the second mode is made to take place, and when the modulation factor Fm becomes smaller than the second threshold value Fmtb, transition from the second mode to the first mode is made to take place. The second threshold value Fmtb may be the same as the first threshold value Fmta or may be smaller than the first threshold value Fmta. For example, the first threshold value Fmta is 1, and the second threshold value Fmtb is 0.8. The mode signal Ss represents the mode determined by the mode determination unit 553.

The multiplier 560 multiplies the third d-axis voltage value Vd3* and the third q-axis voltage value Vq3* by the correction coefficient Kh. The results of the multiplication are outputted as the d-axis voltage command value and the q-axis voltage command value from the voltage command value generator 115.

For example, the modulation factor calculator 551 has an amplitude calculator 5511, a coefficient multiplier 5512, and a divider 5513, as shown in FIG. 10.

The amplitude calculator 5511 determines a square root of the sum of the square of the d-axis voltage value Vd3* and the square of the q-axis voltage value Vq3*, and outputs the result of the calculation as an amplitude Vdq3*_abs. This process is represented by the following equation (8).

[Mathematical Expression 8]

Vdq3*_abs=Vd3*+Vq3* (8)

The coefficient multiplier 5512 multiplies the input voltage Vdc by a coefficient (1/√2).

The divider 5513 divides the output Vdq3*_abs of the amplitude calculator 5511 by the output Vdc/√2 of the coefficient multiplier 5512, and outputs the result of the division as the modulation factor (pre-correction modulation factor) Fm.

The above-mentioned control is adopted for the following reason.

As was mentioned above, generally, when PI control is conducted in the over-modulation range, a wind-up phenomenon in which the integral term is saturated may occur, and the current control system becomes unstable. This is because, in the over-modulation range, the error in the voltage actually applied to the motor 7, with respect to the voltage command value becomes large, and the integral term gradually increases.

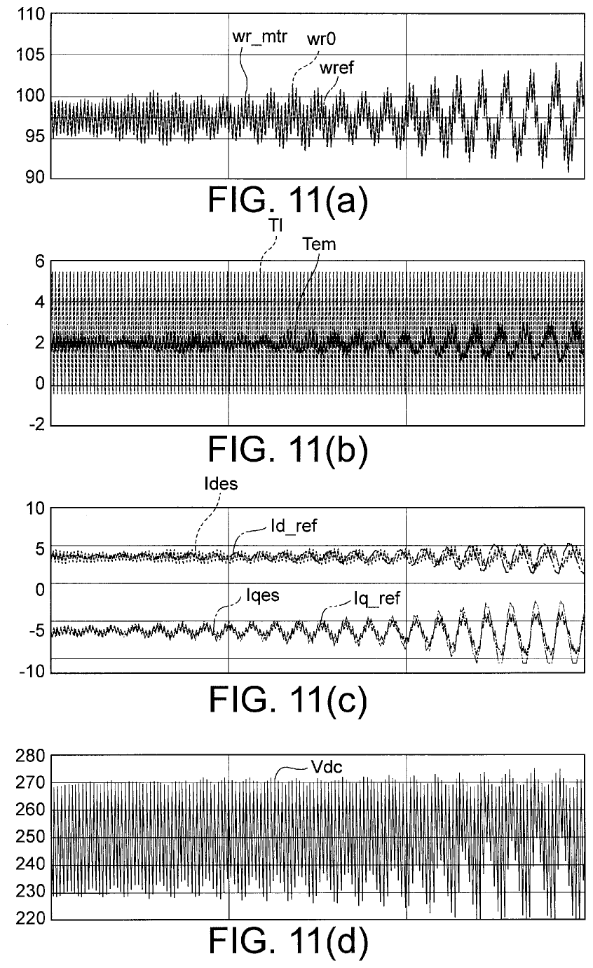

FIGS. 11(a) to 11(d) shows an example of what happens.

FIG. 11(a) shows speed values. The speed values shown take “rps” as a unit. The sign wref denotes the speed command value (corresponding to the frequency command value ω*), the sign wr0 denotes the estimated speed (corresponding to the frequency estimated value ωₑₛₜ), and wr_mtr denotes the actual speed.

FIG. 11(b) shows torque values. The torque values shown take “Nm” as a unit. The sign Tem denotes the output torque of the motor 7, and the sign Ti denotes the load torque.

FIG. 11(c) shows current values. The current values shown take “A” as a unit. The sign Id_ref denotes the d-axis current command value Id*, the sign Ides denotes an estimated value of the actual d-axis current, the sign Iq_ref denotes the q-axis current command value Iq*, and the sign Iges denotes an estimated value of the actual q-axis current.

FIG. 11(d) shows the input voltage Vdc, which takes “V” as a unit.

It will be seen from FIGS. 11(a) to 11(d), the deviations of the actual currents with respect to the current command values increase gradually, and, together therewith, the variations in the speed, the torque, and the input voltage gradually increase.

In the present embodiment, the operation is performed in the first mode until the modulation factor reaches 1, whereas, when the modulation factor becomes larger than 1 (i.e., in the over-modulation range), the operation is performed in the second mode.

In the first mode, the PI control and the non-interference control based on the current command value are performed.

In the second mode, the PI control is not performed, i.e., the results of the PI calculation are not used, and the non-interference control alone is performed, and the compensation values generated as a result of the non-interference control are outputted as the third d-axis voltage value Vd3* and the third q-axis voltage value Vq3*, and the voltage command values Vd* and Vq* are generated based on the third d-axis voltage value Vd3* and the third q-axis voltage value Vq3*.

Specifically, the modulation factor Fm is determined based on the voltage values Vd3* and Vq3*, the correction coefficient Kh is generated based on the modulation factor Fm, the voltage command values Vd* and Vq* are generated by multiplying the voltage values Vd3* and Vq3* by the correction coefficient Kh, and the voltage command values Vd* and Vq* are supplied to the inverter control signal generator 119.

As mentioned above, the voltage values Vd3* and Vq3* have a character as voltage command values before the correction. Therefore, the process of multiplying the voltage values Vd3* and Vq3* by the correction coefficient Kh can be said to be a process of correcting the voltage command values.

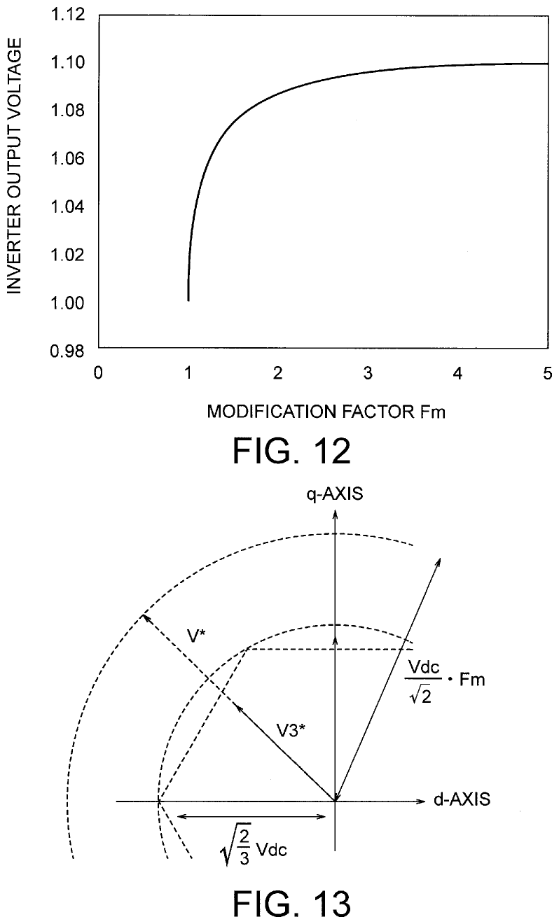

The reason why the relation between the modulation factor and the correction coefficient is made to be as shown in FIG. 9 is that there is a tendency that the rate of increase in the actually outputted voltage with respect to the increase in the modulation factor becomes smaller with increase in the modulation factor as shown in FIG. 12, that is, there is a characteristic in which the output voltage is saturated with increase in the modulation factor. To cancel the effects of such a tendency, i.e., the saturation characteristic, the rate of increase in the correction coefficient is made to be larger with increase in the modulation factor. As mentioned above, the correction of the voltage command value using the correction coefficient can be regarded as correction of the modulation factor.

Change in the voltage command vector due to the multiplication by the correction coefficient (modulation factor correction) is shown in FIG. 13.

When the modulation factor correction is not applied, the vector V3* (Vd3*, Vq3*) corresponding to the voltage values Vd3* and Vq3* outputted from the voltage value calculator 520 is limited within a hexagon having vertices on a circle having a radius of √(2/3)·Vdc.

Accordingly, the modulation factor cannot be made larger than about √(2/3)/1/√2≈1.15.

On the other hand, the vector V* corresponding to the voltage command values Vd* and Vq* obtained by multiplying the voltage values Vd3* and Vq3* by the correction coefficient has a larger value. As a result, voltages corresponding to the magnitude of the vector V3* corresponding to the voltage values Vd3* and Vq3* are outputted from the inverter 30, and applied to the motor 7.

That is, by performing the correction of the voltage command values (correction of the modulation factor), even in the over-modulation range, voltages corresponding to the voltage values (pre-correction voltage command values) Vd3*, Vq3* can be applied to the motor 7, and the operation can be made stable.

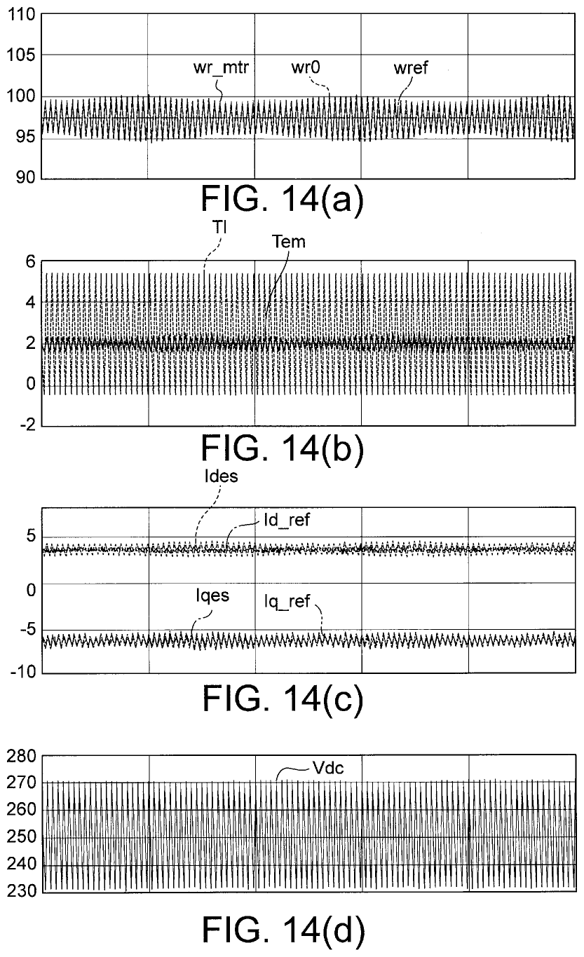

The variations in the currents and the like, when the results of the PI control are not used are, for example, as shown in FIGS. 14(a) to 14(d).

FIG. 14(a) shows the speed values. The speed values shown take “rps” as a unit. The sign wref denotes the speed command value (corresponding to the frequency command value a*), the sign wr0 denotes the estimated speed (corresponding to the frequency estimated value ωₑₛₜ), and wr_mtr denotes the actual speed.

FIG. 14(b) shows the torque values. The torque values shown take “Nm” as a unit. The sign Tem denotes the output torque of the motor 7, and the sign Ti denotes the load torque.

FIG. 14(c) shows the current values. The current values shown take “A” as a unit. The sign Id_ref denotes the d-axis current command value Id*, the sign Ides denotes an estimated value of the actual d-axis current, the sign Iq_ref denotes the q-axis current command value Iq*, and the sign Iges denotes an estimated value of the actual q-axis current.

FIG. 14(d) shows the input voltage Vdc, which takes “V” as a unit.

It will be seen from FIGS. 14(a) to 14(d) that the deviations of the actual currents with respect to the current command values are maintained small, and the variations in the speed, the torque, and the input voltage are also maintained small.

In the present embodiment, in the process of limiting the d-axis current command value and the q-axis current command value, the limit values used in the second mode are set to be larger than the limit values used in the first mode, as mentioned above.

The reason for doing so is explained below.

As was mentioned above, in the second mode, the switches 5215, 5216, 5225 and 5226 are open, so that the compensation values Vdff* and Vqff* represented by the equations (4a) and (4b) become the voltage values Vd3* and Vq3*, and the voltage command values Vd* and Vq* are determined according to the voltage values Vd3* and Vq3*.

As will be understood from the equations (4a) and (4b), the compensation values Vdff* and Vqff* are determined according to the output (Iq*) of the speed controller 503, and the output (Id*) of the d-axis current command value generator 114 including the magnetic flux weakening controller 410, and do not depend on the outputs of the proportional calculators 5211 and 5221, and the integral calculators 5212 and 5222.

Therefore, the voltage command value Vd* does not include a voltage component for reducing the difference between the d-axis current command value and the actual d-axis current, and the voltage command value Vq* does not include a voltage component for reducing the difference between the q-axis current command value and the actual q-axis current.

As a result, the deviation of the actual current from the current command value may not approach zero if the motor constants used in the calculation for control differ from the actual motor constants.

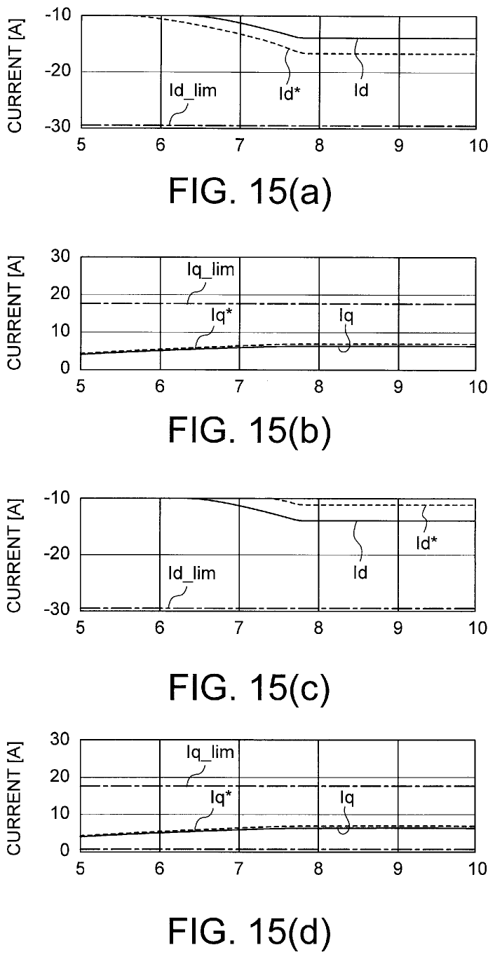

For example, FIG. 15(a) to FIG. 15(d) show waveforms when the d-axis inductance Ld used for control differs from the actual value of the d-axis inductance.

FIGS. 15(a) and 15(b) show a case in which the value of the d-axis inductance Ld used for control is 0.8 times the actual value. In this case, because of the magnetic flux weakening control, the d-axis current command value Id* becomes larger in the negative direction, compared with the actual current Id.

FIGS. 15(c) and 15(d) show a case in which the value of the d-axis inductance Ld used for control is 1.2 times the actual value. In this case, because of the magnetic flux weakening control, the d-axis current command value Id* becomes smaller in the negative direction compared with the actual current Id.

Taking into consideration the fact that the errors become larger, the limit values for the current command values are set to be relatively large.

For example, the limit value Idlim for the d-axis current command value Id* outputted from the d-axis current command value generator 114 may be defined according to the equation (9) based on a voltage equation.

[Mathematical Expression 9]

Idlim=(φf/Ld)×Km (9)

In the equation (9), Km denotes a coefficient.

When the coefficient Km in the equation (9) is 1, it means that the magnetic flux weakening control is performed up to the point at which the voltage phase with reference to the q-axis is 90 [deg]. Incidentally, when the voltage phase is larger than 90 [deg], the control collapses.

In the above configuration, in the second mode, as shown in FIG. 15(a), the d-axis current command value and the actual d-axis current do not agree with each other, and control is performed using the compensation value Vqff* calculated based on the d-axis current command value Id*, so that the operation may become stable after the d-axis current command value Id* becomes equal to the limit value Idlim for a case in which the coefficient Km in the equation (9) is larger than 1.

It is therefore desirable that, for example, the limit value for the d-axis current command value Id* used in the second mode is set to have a larger absolute value than the limit value used in the first mode (when the modulation factor is 1 or less), by the maximum value of the absolute value of the estimated deviation (deviation del_Id of the actual current Id from the d-axis current command value Id*).

Alternatively, the limit value used in the second mode may be so set that its absolute value is 1.2 times or so, compared with the limit value used in the first mode.

For using different limit values between the first mode and the second mode, for example, the mode signal Ss may be inputted to the limiter 423, as shown in FIG. 5, and the limiter 423 may switch the limit value depending on the mode signal Ss.

Similarly, with regard to the q-axis current command value Iq*, it is desirable that the limit value used in the second mode is set to have a larger absolute value than the limit value used in the first mode (when the modulation factor is 1 or less), by the maximum value of the absolute value of the estimated deviation del_Iq (deviation of the actual current Iq from the q-axis current command value Iq*).

Alternatively, the limit value used in the second mode may be so set that its absolute value is 1.2 times or so, compared with the limit value used in the first mode.

The limit value for the q-axis current command value Iq* is set for example in the limiter 5035 in FIG. 7.

For using different limit values between the first mode and the second mode, the mode signal Ss may be inputted to the limiter 5035, as shown in FIG. 7, and the limiter 5035 may switch the limit value depending on the mode signal Ss.

Incidentally, instead of using the larger limit value as described above, the current command value may be made to have a larger value.

For making the d-axis current command value Id* larger, for example, the value of the coefficient Kifw used in the integrator 415 in the d-axis current command value generator 114 in FIG. 5 may be made larger.

For using the coefficient of different values between the first mode and the second mode, for example, the mode signal Ss may be inputted to the integrator 415 as shown by the dotted line in FIG. 5, and the integrator 415 may switch the value of the coefficient Kifw depending on the mode signal Ss.

For making the q-axis current command value Iq* larger, for example, the values of the coefficients used for the multiplication in the coefficient multipliers 5031 and 5032 in the speed controller 503 shown in FIG. 7 may be made larger.

For switching the coefficients between the first mode and the second mode, for example, the mode signal Ss may be inputted to the coefficient multiplier 5031 and the coefficient multiplier 5032, as shown by the dotted line in FIG. 7, and each of the coefficient multiplier 5031 and the coefficient multiplier 5032 may switch the value of the corresponding coefficient depending on the mode signal Ss.

In the example described above, in the second mode, the outputs of the proportional calculators 5211 and 5221, and the outputs of the integral calculators 5212 and 5222 are not used, but it may be so arranged that the outputs of the proportional calculators 5211 and 5221 are used, and the outputs of the integral calculators 5212 and 5222 are not used.

In this case, the voltage values Vd3* and Vq3* are given by the following equations (10a) and (10b).

[Mathematical Expression 10]

Vd3*=Vdfbp*+Vdff* (10a)

Vq3*=Vqfbp*+Vqff* (10b)

Wind-up occurs because the result of the integral calculation is used. By not using the result of the integral calculation, the wind-up can be prevented.

In the example described above, the magnetic flux weakening controller 410 determines the d-axis current command value Id_fw* by the integral-type magnetic flux weakening control. Alternatively, the d-axis current command value Id_fw* may be calculated according to the following equation (11) based on a voltage equation.

$$\begin{matrix}[ Mathematical Expression 11 ] & \\ {Id\_fw}^{*} = \frac{- {ϕ}_{a} \pm \sqrt{{( \frac{Vom}{ω} )}^{2} + {( Lq \cdot Iq )}^{2}}}{Ld} & ( 11 )\end{matrix}$$

In the equation (11),

Vom denotes a restriction value, which can be calculated in the same manner as described with reference to the coefficient multiplier 412 and the multiplier 413 shown in FIG. 5.

ω denotes the frequency of the output voltages of the inverter 30.

In the example described above, the phase currents Iu, Iv and Iw are restored from the input current Idc of the inverter 30. Alternatively, current detectors may be provided on the output lines 331, 332 and 333 of the inverter 30, and the phase currents may be detected by the current detectors. In such a case, the currents detected by the current detectors may be used in place of the currents restored by the current restoration unit 111.

As the switching elements 311 to 316 of the inverter main circuit 310, it was assumed that IGBTs (Insulated Gate Bipolar Transistors) or MOSFETs are used. However, any type of elements capable of switching may be used. Incidentally, in the case of MOSFETs, parasitic diodes are structurally provided, so that separate free-wheeling diode elements (321 to 326) need not be connected in reverse parallel, but yet similar results can be obtained.

The material of the switching elements 311 to 316 need not be limited to silicon (Si). By forming the switching elements 311 to 316 by using wide-gap semiconductor, e.g., silicon carbide (SiC), gallium nitride (GaN), diamond, or the like, the loss can be reduced further.

The configuration of the embodiment described above is an example of the present invention, and may be combined with other known technology, or part of the configuration can be omitted, or changed without departing from the spirit of the invention.

### INDUSTRIAL APPLICABILITY

Description has been made on the motor driving apparatus, and the refrigeration cycle equipment provided therewith. Description has been made in particular to cases where the refrigeration cycle equipment is one used in an air conditioner. However, the refrigeration cycle equipment may be one used in a refrigerator, a freezer, a heat-pump type hot water dispenser, or the like.

1. A motor driving apparatus having
an inverter to generate AC voltages with a variable frequency and a variable voltage value and to apply the AC voltages to a motor, and
a control device to control said inverter, wherein
said control device
generates a q-axis current command value based on a frequency deviation which is a difference of a frequency of said AC voltages with respect to a frequency command value,
generates a first d-axis voltage value by performing proportional calculation on a d-axis current deviation which is a difference of a d-axis current of said motor with respect to a d-axis current command value,
generates a second d-axis voltage value by performing integral calculation on said d-axis current deviation,
calculates a d-axis compensation value for compensating a d-axis voltage induced by said q-axis current command value,
generates a first q-axis voltage value by performing proportional calculation on a q-axis current deviation which is a difference of a q-axis current of said motor with respect to said q-axis current command value,
generates a second q-axis voltage value by performing integral calculation on said q-axis current deviation, and
calculates a q-axis compensation value for compensating a q-axis voltage induced by said d-axis current command value, wherein
in a first mode, said control device
generates a third d-axis voltage value using said first d-axis voltage value, said second d-axis voltage value, and said d-axis compensation value, and
generates a third q-axis voltage value using said first q-axis voltage value, said second q-axis voltage value, and said q-axis compensation value, and
in a second mode, said control device
generates said third d-axis voltage value using at least said d-axis compensation value and without using said second d-axis voltage value, among said first d-axis voltage value, said second d-axis voltage value, and said d-axis compensation value, and
generates said third q-axis voltage value using at least said q-axis compensation value, and without using said second q-axis voltage value, among said first q-axis voltage value, said second q-axis voltage value, and said q-axis compensation value, and
said control device
calculates a modulation factor based on said third d-axis voltage value and said third q-axis voltage value,
calculates a correction coefficient based on said modulation factor,
generates a d-axis voltage command value and a q-axis voltage command value by multiplying said third d-axis voltage value and said third q-axis voltage value by said correction coefficient,
generates signals for PWM control over said inverter based on said d-axis voltage command value and said q-axis voltage command value,
wherein
said correction coefficient is maintained at 1 in said first mode, and
in said second mode, said correction coefficient is so determined that said AC voltages will be of a magnitude corresponding to said third d-axis voltage value and said third q-axis voltage value.

2. The motor driving apparatus as set forth in claim 1, wherein,
in said first mode,
said control device
generates said third d-axis voltage value by adding said first d-axis voltage value, said second d-axis voltage value, and said d-axis compensation value, and
generates said third q-axis voltage value by adding said first q-axis voltage value, said second q-axis voltage value, and said q-axis compensation value.

3. The motor driving apparatus as set forth in claim 2, wherein,
in said second mode,
said control device
generates said third d-axis voltage value by adding said first d-axis voltage value and said d-axis compensation value, and
generates said third q-axis voltage value by adding said first q-axis voltage value and said q-axis compensation value.

4. The motor driving apparatus as set forth in claim 2, wherein,
in said second mode,
said control device uses said d-axis compensation value as said third d-axis voltage value, and uses said q-axis compensation value as said third q-axis voltage value.

5. The motor driving apparatus as set forth in claim 1, wherein
in said second mode,
said correction coefficient is so determined that increase in said correction coefficient relative to increase in said modulation factor is larger as said modulation factor becomes larger.

6. The motor driving apparatus as set forth in claim 1, wherein, in said second mode, said correction coefficient is so determined as to cancel a characteristic by which said AC voltages become saturated against increase in said modulation factor.

7. The motor driving apparatus as set forth in claim 1, wherein
said control device
selects said second mode when said modulation factor becomes larger than a first threshold value, and
selects said first mode when said modulation factor becomes smaller than a second threshold value which is not larger than said first threshold value.

8. The motor driving apparatus as set forth in claim 1, wherein said control device calculates a d-axis current value based on an input voltage of said inverter, said d-axis voltage command value, and said q-axis voltage command value, and applies restriction on an absolute value of said d-axis current value using a limit value to generate said d-axis current command value.

9. The motor driving apparatus as set forth in claim 8, wherein the limit value used in said second mode is larger than the limit value used in said first mode.

10. The motor driving apparatus as set forth in claim 9, wherein said limit value used in said second mode is larger than said limit value used in said first mode by a maximum value of an estimated value of said d-axis current deviation.

11. The motor driving apparatus as set forth in claim 8, wherein said d-axis current value calculated in said second mode is larger than said d-axis current value calculated in said first mode.

12. The motor driving apparatus as set forth in claim 11, wherein said d-axis current value calculated in said second mode is so calculated as to be of a value obtained by multiplying said d-axis current value calculated in said first mode by a predetermined coefficient larger than 1.

13. The motor driving apparatus as set forth in claim 1, wherein said control device
generates a q-axis current value by performing proportional and integral calculation on said frequency deviation, and
generates said q-axis current command value by applying restriction on an absolute value of said q-axis current value, using a limit value, wherein
the limit value used in said second mode is larger than the limit value used in said first mode.

14. The motor driving apparatus as set forth in claim 13, wherein said limit value used in said second mode is larger than said limit value used in said first mode by a maximum value of an estimated value of said q-axis current deviation.

15. The motor driving apparatus as set forth in claim 1, wherein said q-axis current command value generated in said second mode is larger than said q-axis current command value generated in said first mode.

16. The motor driving apparatus as set forth in claim 15, wherein said q-axis current command value generated in said second mode is so determined to be of a value obtained by multiplying the q-axis current command value generated in said first mode by a predetermined coefficient larger than 1.

17. Refrigeration cycle equipment having the motor driving apparatus as set forth in claim 1.

18. An air conditioner having the refrigeration cycle equipment as set forth in claim 17.
